(19) United States
(12) Patent Application Publication
(10) Pub. No.: US 2008/0127291 A1
(43) Pub. Date: May 29, 2008

(54) METHOD AND APPARATUS FOR TRANSMITTING/RECEIVING BROADCASTING SERVICE IN DIGITAL BROADCASTING SYSTEM

(75) Inventors: Yiling XU, Suwon-si (KR); Jae-Yeon Song, Seoul (KR); Kook-Heui Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/937,248

(22) Filed: Nov. 8, 2007

Related U.S. Application Data
(60) Provisional application No. 60/857,509, filed on Nov. 8, 2006.

(30) Foreign Application Priority Data
Jun. 29, 2007 (KR) 2007-65305

(51) Int. Cl. H04N 7/173

(52) U.S. Cl. 725/118; 725/131

(57) ABSTRACT

Provided is a method and apparatus for transmitting/receiving a service in a digital broadcasting system. When a user desires to continue receiving a service in an Internet Protocol (IP) platform other than an IP platform to which the user belongs, a network provides service mapping information to a terminal. Thus, even when the user moves to another IP platform while viewing a user-selected service, the terminal can continue receiving the service.

### PRIORITY

This application claims priority under 35 U.S.C. § 119(a) to a U.S. Provisional Patent Application filed in the U.S. Patent Office on Nov. 8, 2006 and assigned Ser. No. 60/857,509 and a Korean Patent Application filed in the Korean Intellectual Property Office on Jun. 29, 2007 and assigned Serial No. 2007-65305, the contents of both of which are incorporated herein by reference.

### BACKGROUND OF THE INVENTION

1. Field of the Invention

The present invention relates generally to a digital broadcasting system, and more particularly to a method and apparatus for helping a terminal to easily find a desired service.

2. Description of the Related Art

A Digital Video Broadcasting-Handheld (DVB-H) Convergence of Broadcasting and Mobile Service (CBMS) system, which is one type of digital broadcasting system, provides more convenient functions through the convergence of a digital TeleVision (TV) broadcast service having superior mobile reception performance and a mobile communication service. Recently, as analog TVs evolve into digital TVs, users can enjoy a TV service with high video quality of a High Definition (HD) TV level and high audio quality of a Compact Disc (CD) level. However, with the current tendency toward diversification, viewers' current activities and life patterns are different from those of the past. Moreover, as portable devices such as cellular phones, Personal Digital Assistants (PDAs) and notebook computers have become commonly-used, the demand for enjoying a TV service of HD quality while on the move is ever-increasing. Additionally, much effort has been made much to overcome the limitation of a broadcast network having no reverse channel by combination with mobile communication, resulting in the DVB-H CBMS.

The DVB-H CBMS is configured for a reception terminal capable of using a mobile communication channel and includes the concept of handover supported in a cell-based radio communication system such as in a conventional mobile communication system. However, handover in a broadcast network is different from that in a mobile communication network that constantly manages subscribers. For handover in a mobile communication system, a network receives a measurement report from a terminal to manage an individual user and a network including handover. However, for handover in a general broadcast system, a broadcast operator provides a service and contents without managing every user. In other words, the broadcast operator sends information for broadcast reception to all users over a broadcast network and has no user management function. Thus, handover in the broadcast network has unique technical requirements that are distinguished from handover in the mobile communication system.

FIG. 1 illustrates a conventional DVB-H system. Entities illustrated in FIG. 1 are logical entities that may or may not be physically distinguished and can be combined into one or more physical entities. In FIG. 1, only interfaces related to the subject matter of the present invention are shown. The DVB-H system shown in FIG. 1 is intended for the DVB-CBMS, one of handheld broadcasting terminal standard organizations. Although a notification broadcast structure of the DVB-CBMS is taken as an example for convenience of explanation herein, the present invention can also be implemented in other types of handheld broadcasting systems having a notification messaging function in the similar manner.

Referring to FIG. 1, a Content Creation (CC) 110 is a provider of a broadcast service, which includes, for example, conventional audio/video broadcast services and a file (music or data file) download service. If a problem arises in providing the broadcast service or any change in the broadcast service, the CC 110 notifies the problem or change to a notification event generation function in a Service Application (SA) 120.

The SA 120 is provided with content data for the broadcast service from the CC 110 and processes the content data into a form (e.g., audio/video streaming or movie downloading) suitable for a broadcast network in order to generate broadcast service data, generates standardized metadata necessary for an Electronic Service Guide (ESG), and generates billing information according to a user. The SA 120 is also notified of the change in the broadcast service from the CC 110 to deliver a notification event to a notification message generation function in a Service Management (SM) 130 and provides service guide attribute information used for the generation of a notification message to the notification message generation function.

The SM 130 determines a transmission schedule for the broadcast service provided from the SA 120 and generates a service guide. The SA 130 is connected to a broadcast network 140 capable of the broadcast service and an interactive network 150 supporting interactive communication.

The SM 130 also manages subscriber information for reception of the broadcast service, service provisioning information such as information indicating whether the subscriber has purchased related content, and device information for terminals receiving the broadcast service, transmits user billing information to the SA 120, and provides the subscription information, the service provisioning information and the device information to the broadcast network 140 and the interactive network 150.

The broadcast network 140 is for transmitting the broadcast service and DVB-H is as an example of the broadcast network 140 herein.

The interactive network 150 transmits the broadcast service on a point-to-point basis or interactively exchanges control information and additional information associated with the reception of the broadcast service, and may be an existing cellular network such as the 3^{rd} Generation Partnership Project (3GPP) Wideband Code Division Multiple Access (WCDMA) network.

A terminal 160 is capable of receiving the broadcast service and has a function of accessing the cellular network according to its capabilities. It is assumed herein that the terminal 160 can access the cellular network.

Next, a description will be made of interfaces between block elements of the DVB-H system.

CBMS-x is an interface within the scope of the Internet Protocol (IP) Datacast over DVB-H specification, and X-x is an interface out of the scope of the IP Datacast over DVB-H specification. More specifically, a CBMS-7 interface extends from the SA 120 to the SM 130, and a CBMS-3 interface directly transmits a message from the SM 130 to the terminal 160 on a broadcast channel via the broadcast network 140. A CBMS-4 interface is used to directly transmit the message transmitted from the SA 130 to the terminal 160 via the interactive network 150 on a dedicated channel with the terminal 160 or a broadcast channel provided by the interactive network 150. A CBMS-6 interface is between the SM 130 and the broadcast network 140, and is used as a transmission path to be used by the SA 130 in the broadcast network 140 or as a reception path of event information generated in the broadcast network 140. A CBMS-1 interface is used to deliver a control signal of the broadcast network to the terminal 160. For example, in DVB-H, a control signal channel called Program Specific Information/Service Information (PSI/SI) corresponds to the control signal. An X-3 interface is used to set up a transmission path to be used between the SM 130 and the interactive network 150. An X-2 interface is used to set up a transmission path to be used between the terminal 160 and the interactive network 150. An X-1 interface is used to set up a transmission path to be used between the CC 110 and the SA 120.

When a user in a DVB-H network moves from a reference network to a neighboring network or to another IP platform, the new network or IP platform to which the user moves has to seamlessly provide a previous service used by the user. A terminal has to find a program viewed by the user prior to handover in the new network and continue receiving the program. In other words, a Transport Stream (TS) providing the same service has to be found in the new network or IP platform when a TS is changed, and frequency information of the new network or IP platform has to be known when a transmission frequency is changed. Information required to perform the above-described process can be acquired by PSI/SI provided by a DVB broadcast network. In this case, detailed handover procedure and method fall out of the scope of the present invention and thus will not be described in detail. Related information is described in ETSI TR 101 211 Digital Video Broadcasting (DVB); Guidelines on implementation and usage of Service Information (SI).

In the above-described process, a service identifier plays an important role in finding the program viewed by the user. This concept is also applied to movement between cells and sub-cells in the same manner. When the previous service viewed by the user does not exist in the new network or IP platform to which the user moves, the terminal searches for a service capable of substituting for the previous service in the new network or IP platform. Herein, the previous service and the service capable of substituting for the previous service may have different programs according to locations, but are similar in nature.

As discussed above, even when a DVB-H terminal moves, it can allow a user to seamlessly view a user selected service and provide necessary information to the user and the terminal itself. However, according to the prior art, when service identifiers of a previous network in which the terminal is previously located and a new network to which the terminal moves are different, the terminal cannot find a correct service. Neither can the terminal find a correct service when service identifiers of a previous IP platform in which the terminal is previously located and a new IP platform to which the terminal moves are different. In other words, if different networks or IP platforms assign different service identifiers to the same service, the terminal has difficulty finding a desired service in a new network or IP platform to which the terminal moves.

### SUMMARY OF THE INVENTION

An aspect of the present invention is to address at least the above problems and/or disadvantages and to provide at least the advantages described below. Accordingly, an aspect of the present invention is to provide a method and apparatus for helping a terminal to find the same or similar service in other IP platforms and continue the service.

According to the present invention, there is provided a method for providing a broadcast service to a terminal by a network in a digital broadcasting system. The method includes collecting IP address information for each of services provided by a plurality of IP platforms, selecting a manner in which to transmit the collected IP address information to the terminal, and transmitting the collected IP address information to the terminal in the selected manner.

According to the present invention, there is provided a method for receiving a broadcast service from a network by a terminal in a digital broadcasting system. The method includes receiving IP address information for each of services provided by a plurality of IP platforms from the network, checking IP address information of the service provided by the another IP platform if a currently received service is substantially the same as a service provided by another IP platform, and continuing to receive the service provided by the another IP platform using the checked IP address information.

According to the present invention, there is provided a method for providing a broadcast service to a terminal by a network in a digital broadcasting system. The method includes collecting service ID information for each of services provided by a plurality of providers, selecting a manner in which to transmit the collected service ID information to the terminal, and transmitting the collected service ID information to the terminal in the selected manner.

According to the present invention, there is provided a method for receiving a broadcast service from a network by a terminal in a digital broadcasting system. The method includes receiving service ID information for each of services provided by a plurality of providers from the network, checking service ID information of the service provided by the another provider if a currently received service is also provided by another provider, and continuing to receive the service provided by the another provider using the checked service ID information.

According to the present invention, there is provided a method for providing a broadcast service to a terminal by a network in a digital broadcasting system. The method includes collecting service ID information and IP address information for each of services provided by a plurality of providers within a single IP platform, selecting a manner in which to transmit the collected service ID information and IP address information to the terminal, and transmitting the collected service ID information and IP address information to the terminal in the selected manner.

According to the present invention, there is provided a method for receiving a broadcast service from a network by a terminal in a digital broadcasting system. The method includes receiving service ID information and IP address information for each of services provided by a plurality of providers within a single IP platform, checking service ID information and IP address information of the service provided by the another provider if a currently received service is also provided by another provider, and continuing to receive the service provided by the another provider using the checked service ID information and IP address information.

According to the present invention, there is provided a network device for providing a broadcast service to a terminal in a digital broadcasting system. The network device includes an SA for aggregating contents from sources and their related metadata in order to provide an application for a particular service and an SM for generating an ESG for the broadcast service from the metadata collected by the SA and managing roaming of the terminal to a neighboring network. The SM collects mapping information of services provided from different IP platforms or different providers from the IP platforms or providers and provides the collected mapping information to the terminal.

According to the present invention, there is provided a terminal device for receiving a broadcast service from a network. The terminal device includes a broadcasting receiver for receiving a broadcast service or signal from a broadcast network, an interactive adaptor for receiving an interactive service or signal from an interactive network, and a mobility management and control for managing roaming to a neighboring network. The broadcasting receiver receives mapping information for services provided from different IP platforms or different providers from a network, and the mobility management and control controls to receive a desired service from an IP platform other than the IP platform in which the terminal device is currently located or a provider other than a provider from which the terminal device currently receives the service.

### BRIEF DESCRIPTION OF THE DRAWINGS

The above and other features and advantages of preferred embodiments of the present invention will be more apparent from the following detailed description taken in conjunction with the accompanying drawings, in which:

FIG. 1 illustrates a conventional DVB-H system;

FIG. 2 illustrates a relationship between an IP platform and providers;

FIG. 3 illustrates an IP platform mapping method according to a first embodiment of the present invention;

FIG. 4 illustrates the IP platform mapping method according to the first embodiment of the present invention in a network;

FIGS. 5A and 5B illustrate the IP platform mapping method according to the first embodiment of the present invention in a terminal;

FIG. 6 illustrates a provider mapping method according to a second embodiment of the present invention;

FIG. 7 illustrates the provider mapping method according to the second embodiment of the present invention in a network;

FIGS. 8A and 8B illustrate the provider mapping method according to the second embodiment of the present invention in a terminal;

FIG. 9 illustrates an IP address mapping method in a single IP platform according to a third embodiment of the present invention;

FIG. 10 illustrates the IP address mapping method according to the third embodiment of the present invention in a network;

FIGS. 11A and 11B illustrate the IP address mapping method according to the third embodiment of the present invention in a terminal;

FIG. 12 illustrates the structure of a network according to the present invention; and

FIG. 13 illustrates the structure of a terminal according to the present invention.

### DETAILED DESCRIPTION OF THE PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for the sake of clarity and conciseness. The following terms are defined in consideration of their functions in the present invention and may vary according to a user, an operator's intention or custom. Therefore, their definition should be based on the overall contents of the specification.

While a Digital Video Broadcasting-Handheld (DVB-H) Convergence of Broadcasting and Mobile Service (CBMS) system is an example of a digital broadcasting system, the present invention is not limited thereto and can also be applied to other digital broadcasting systems.

One service can be identified by an IP address that is uniquely assigned within one IP platform, and can also be identified by a service IP which is assigned by a provider. Herein, an IP platform is mapped to an SM based on a one-to-one correspondence. A provider may be, for example, an ESG provider and a service provider that are included in the SM and an SA, respectively.

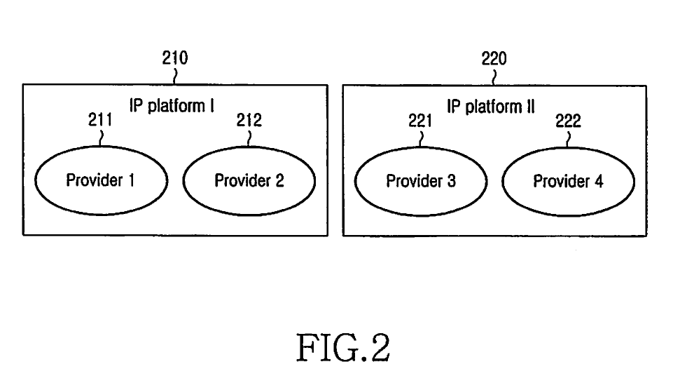

FIG. 2 illustrates a relationship between an IP platform and providers.

As illustrated in FIG. 2, at least one provider may exist in a single IP platform. In other words, a provider-1 211 and a provider-2 212 exist in an IP platform-1 210 and a provider-3 221 and a provider-4 222 exist in an IP platform-2 220. In this condition, to help a terminal to continue a service, there may be various manners in which to provide mapping information of the service to the terminal according to a relationship between an IP platform and providers. In the present invention, the mapping information of the service is stored in the SM.

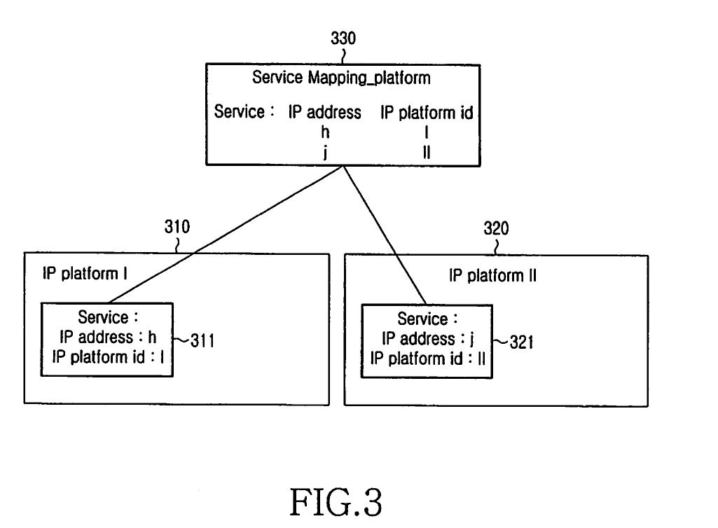

FIG. 3 illustrates an IP platform mapping method according to a first embodiment of the present invention.

As illustrated in FIG. 3, a network provides mapping information 330 of IP addresses and IP platforms for the same or similar services in different IP platforms 310 and 320 to a terminal. In other words, an IP address ‘h’ is assigned to a service 311 in the IP platform-1 310 and an IP address ‘j’ is assigned to a service 321 in the IP platform-2 320. Since the services 311 and 321 are similar to each other, the network provides the mapping information 330 of IP addresses IP platforms between the services 311 and 321 to the terminal. Even when an IP platform changes, such as from the IP platform-1 310 to the IP platform-2 320 or vice-versa, the terminal having received the mapping information 330 can continue receiving a desired service in the changed IP platform.

Table 1 shows the mapping information 330 provided to the terminal.

TABLE 1

| | IP platform_id (actual) | IP platform_id(other) | type |
|---|---|---|---|
| Service | IP address in actual | IP address in other | 1. identical |
| | platform | platform | |
| | | | 2. variation |
| | | | 3. associated |

As shown in Table 1, the terminal only needs to consider the mapping information 330 of IP addresses and IP platforms for the same or similar services. In Table 1, a ‘type’ indicates a relationship between two services and may be one of ‘identical’, ‘variation’ and ‘associated’.

To provide the mapping information 330, the network may define a new element as below.

TABLE 2
<complexType name = ServiceMapping_IP platform” minOccur =”0”
maxOccur=”unbounded”>
<all>
<element name=”IP_address_actual” type=”anyURI”>
<element name=”IP platform_id_actual” type=”anyURI”>
<element name=”IP_address_other” type=”anyURI”>
<element name=”IP platform_id_other” type=”anyURI”>
<element name=”type” type=”anyURI”
</all>
</complexType>

The new element shown in Table 2 may be added in an ESG, e.g., a service fragment, an acquisition fragment, a notification or other signaling in a broadcasting or interactive manner.

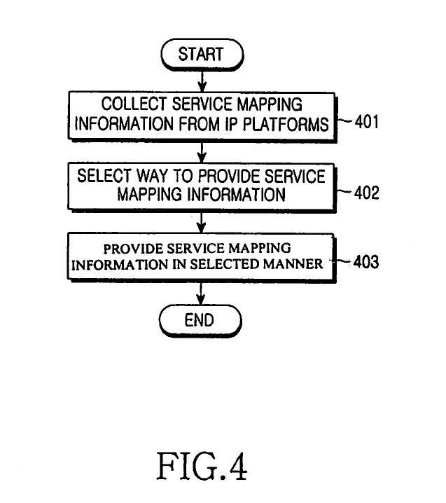

FIG. 4 illustrates the IP platform mapping method according to the first embodiment of the present invention in the network.

Referring to FIG. 4, the network collects service mapping information in different IP platforms in step 401, and selects a manner in which to provide the service mapping information in step 402. An ESG, a notification or other signaling may be used as described above. The network provides the collected service mapping information to a terminal in the selected manner in step 403.

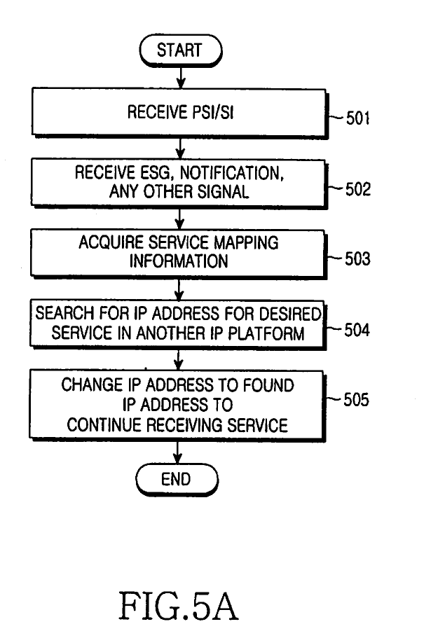

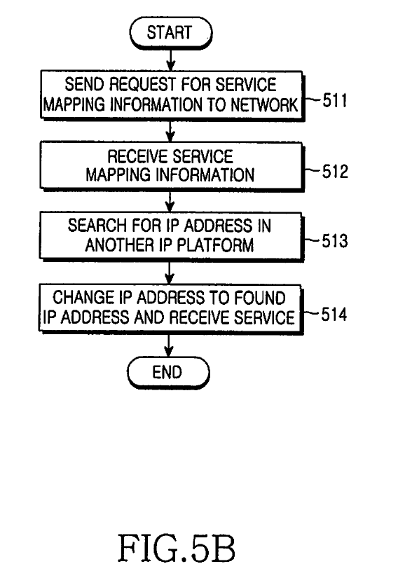

FIGS. 5A and 5B illustrate the IP platform mapping method according to the first embodiment of the present invention in the terminal.

Referring to FIG. 5A, the terminal receives Program Specific Information/Service Information (PSI/SI) from the network in step 501 and receives an ESG, a notification or any other signal in step 502. The terminal acquires service mapping information from the received ESG, notification or other signal in step 503. IP address mapping information among different IP platforms may be added in an IP/MAC Notification Table (INT) of the PSI/SI to be indicated to the terminal.

In step 504, the terminal searches in the acquired service mapping information for an IP address in another IP platform, which corresponds to a currently received service in the current IP platform. In step 505, the terminal changes its IP address to the found IP address to continue receiving the desired service.

The terminal may also send a request for the service mapping information to the network.

In other words, as illustrated in FIG. 5B, when the terminal desires to continue receiving the currently received service in another IP platform, it sends a request for desired service mapping information to the network in step 511 and receives the service mapping information in step 512. In step 513, the terminal searches in the acquired service mapping information for an IP address in another IP platform, which corresponds to the currently received service in the current IP platform. In step 514, the terminal changes its IP address to the found IP address to continue receiving the desired service.

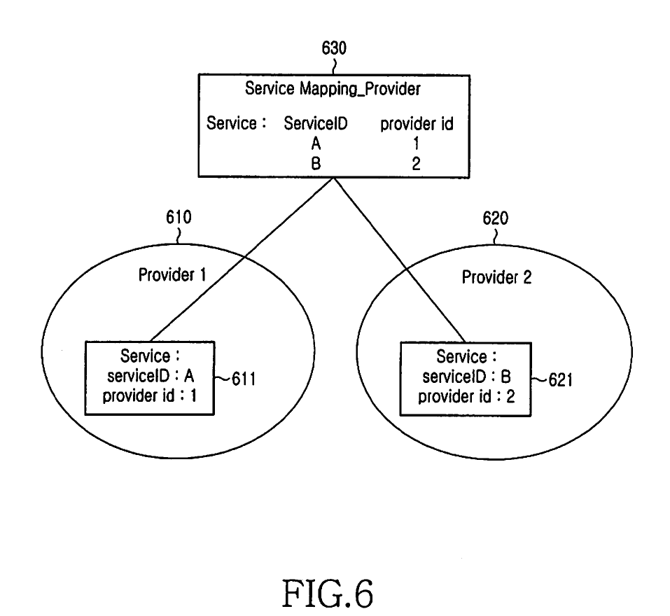

FIG. 6 illustrates a provider mapping method according to a second embodiment of the present invention.

As illustrated in FIG. 6, service ID mapping information for the same or similar services in different providers is provided to the terminal.

In other words, a service ID ‘A’ is assigned to a service 611 in a provider-1 610 and a service ID ‘B’ is assigned to a service 612 in a provider-2 620. Since the service 611 and the service 621 are similar to each other, the network provides service ID mapping information 630 for providers between the services 611 and 621 to the terminal. Even when a provider changes, e.g., from the provider-1 610 to the provider-2 620 or vice-versa, the terminal having received the service IP mapping information 630 can continue receiving the desired service from the changed provider using the service ID mapping information 630.

Table 3 illustrates the service ID mapping information 630 provided to the terminal.

TABLE 3

| | serviceID (actual) | provider_id(other) | type |
|---|---|---|---|
| Service | serviceID in actual | serviceID in other | 1. identical |
| | provider | provider | |
| | | | 2. variation |
| | | | 3. associated |

As shown in Table 3, the terminal only needs to consider a service ID and a provider ID for the same or similar services. In Table 3, a ‘type’ indicates a relationship between two services and may be one of ‘identical’ indicating the same service, ‘variation’ indicating a variation of the same service, and ‘associated’ indicating an associated service.

To provide the service ID mapping information 630, the network may also define a new element as below.

TABLE 4
<complexType name = ServiceMapping_provider” minOccur =”0”
maxOccur=”unbounded”>
<all>
<element name=”serviceID _actual” type=”anyURI”>
<element name=”provider_id_actual” type=”anyURI”>
<element name=”serviceID _other” type=”anyURI”>
<element name=” provider_id_other” type=”anyURI”>
<element name=”type” type=”anyURI”
</all>
</complexType>

The new element shown in Table 4 may be added in an ESG, e.g., a service fragment, an acquisition fragment, a notification or other signaling in a broadcasting or interactive manner.

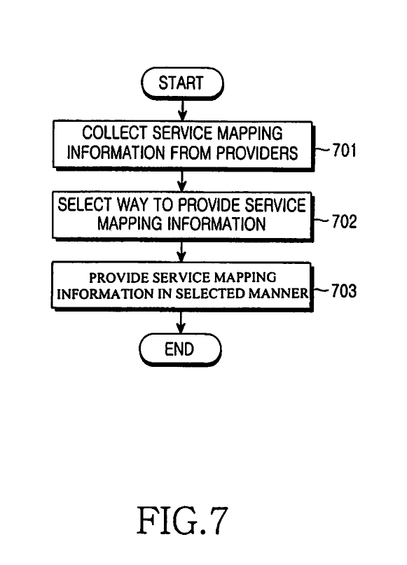

FIG. 7 illustrates the provider mapping method according to the second embodiment of the present invention in the network.

As illustrated in FIG. 7, the network collects service mapping information from different providers in step 701 and selects a manner in which to provide the service mapping information in step 702. An ESG, a notification or other signaling may be used as described above. The network provides the collected service mapping information to a terminal in the selected manner in step 703.

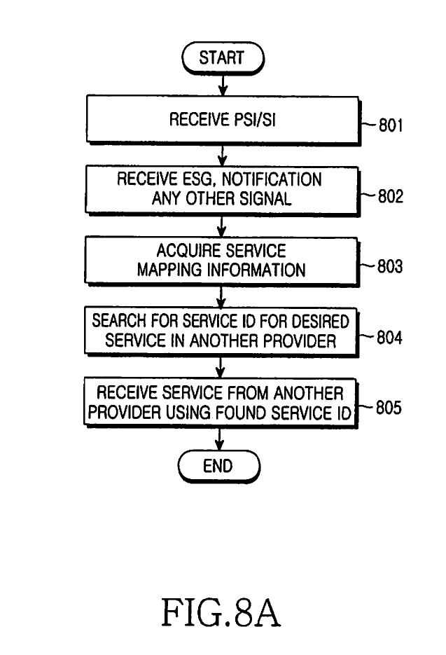

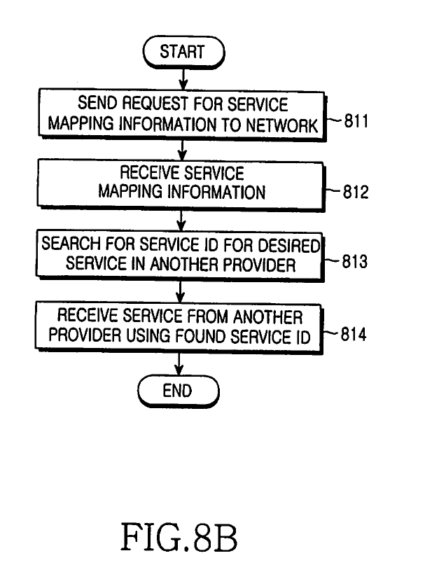

FIGS. 8A and 8B illustrate the provider mapping method according to the second embodiment of the present invention in the terminal.

Referring to FIG. 8A, the terminal receives PSI/SI from the network in step 801 and receives an ESG, a notification or any other signal in step 802. The terminal acquires service mapping information from the received ESG, notification or other signal in step 803. In step 804, the terminal searches in the acquired service mapping information for a service ID in another provider, which corresponds to a currently received service from the current provider. In step 805, the terminal continues receiving the desired service from another provider using the found service ID.

The terminal may also send a request for the service mapping information to the network.

In other words, as illustrated in FIG. 8B, when the terminal desires to continue receiving the currently received service from another provider, it sends a request for desired service mapping information to the network in step 811 and receives the service mapping information in step 812. In step 813, the terminal searches in the acquired service mapping information for a service ID in another provider, which corresponds to the currently received service from the current provider. In step 814, the terminal continues receiving the desired service using the found service ID.

The two manners in which to provide the service mapping information according to the first and second embodiments of the present invention can be used independently or simultaneously. However, when two or more providers (e.g., two ESG providers) exist in a single IP platform and provide the same or similar services, service mapping information may be provided according to a third embodiment of the present invention to be described below, which can be classified into two cases.

First, even when the same service is provided by different providers, an IP platform may assign one unique IP address to the service. In this case, the terminal has to consider IP addresses. In other words, if IP addresses for services provided from different providers are the same, the terminal recognizes these services as the same even when the providers assign different service IDs to the services.

Second, when the same service is provided by different providers, an IP platform may assign different IP addresses to the same service provided by the providers.

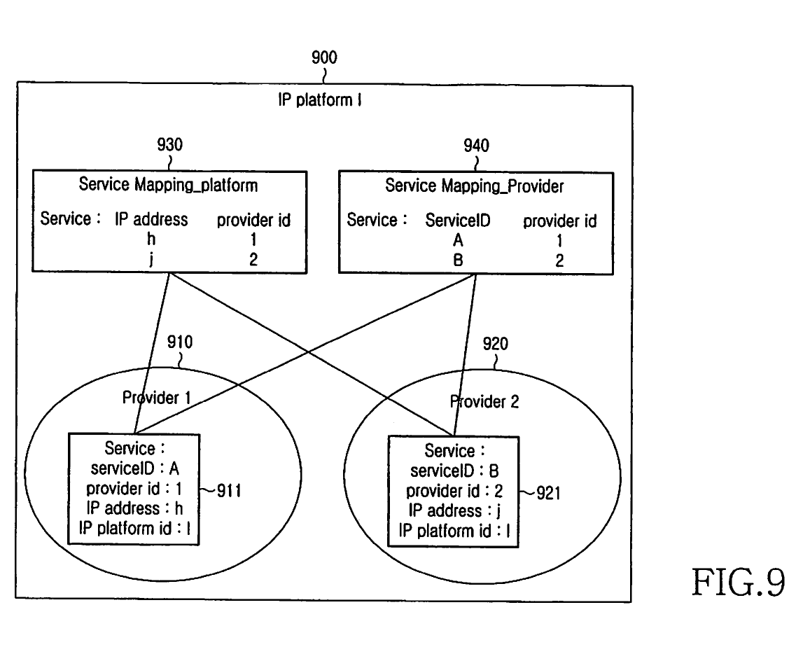

FIG. 9 illustrates a provider mapping method according to the third embodiment of the present invention.

As illustrated in FIG. 9, two providers 910 and 920 exist in a single IP platform 900 and the same or similar services 911 and 921 are provided by the providers 910 and 920. The IP platform 900 assigns different IP addresses to the services 911 and 921 of the providers 910 and 920. In other words, the IP platform 900 assigns an IP address ‘h’ to the service 911 of the provider 910, identified by a service ID A, and an IP address ‘j’ to the service 921 of the provider 920, identified by a service ID B.

In this case, the network provides service ID mapping information 940 between the different providers 910 and 920 or IP address mapping information 930 in the single IP platform 900 to the terminal in order to support service continuity.

The IP address mapping information 930 provided to the terminal is as below.

TABLE 5

| | IP platform_id (actual) | | |
|---|---|---|---|
| | Provider id(actual) | Provider id(other) | type |
| Service | IP address for one | IP address for other | 1. identical |
| | provider | provider | |
| | | | 2. variation |
| | | | 3. associated |

In Table 5, a ‘type’ indicates a relationship between two services and may be one of ‘identical’ indicating the same service, ‘variation’ indicating a variation of the same service and ‘associated’ indicating an associated service.

To provide the IP address mapping information 930, the network may also define a new element as below.

TABLE 6

<complexType name = ServiceMapping_within IP platform”
minOccur =”0”
maxOccur=”unbounded”>
<all>
<element name=”provider_id_actual” type=”anyURI”>
<element name=”IP_address_1” type=”anyURI”>
<element name=”IP_address_2” type=”anyURI”>
<element name=”type” type=”anyURI”
</all>
</complexType>

In Table 6, a mapping IP address for the same or similar services in a single IP platform is listed. Provider information may be added to indicate an IP address for each provider.

If there are two or more mapping IP addresses, two mapping IP addresses may be listed as below.

TABLE 7

<complexType name = ServiceMapping_within IP platform”
minOccur =”0”
maxOccur=”unbounded”>
<all>
<element name=”provider_id_actual” type=”anyURI”>
<element name=”IP_address_1” type=”anyURI”>
<element name=”provider_id_1” type=”anyURI”>
<element name=”IP_address_2” type=”anyURI”>
<element name=”provider_id_2” type=”anyURI”>
<element name=”type” type=”anyURI”
</all>
</complexType>

This new element shown in Table 7 may be added in an ESG, e.g., a service fragment, an acquisition fragment, a notification or other signaling in a broadcasting or interactive manner.

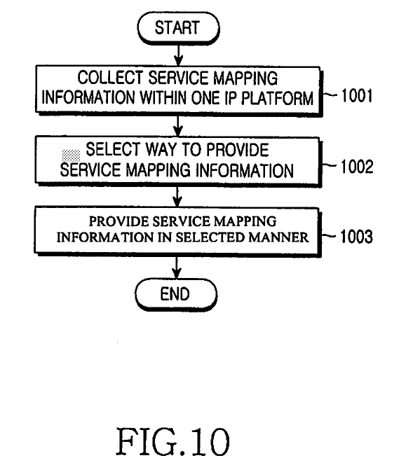

FIG. 10 illustrates the IP address mapping method according to the third embodiment of the present invention in the network.

Referring to FIG. 10, the network collects service mapping information in a single IP platform in step 1001 and selects a manner in which to provide the service mapping information in step 1002. An ESG, a notification or other signaling may be used as described above. The network provides the collected service mapping information to a terminal in the selected manner in step 1003.

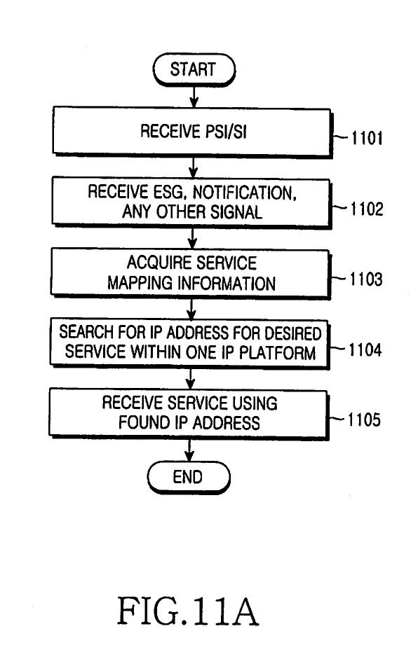

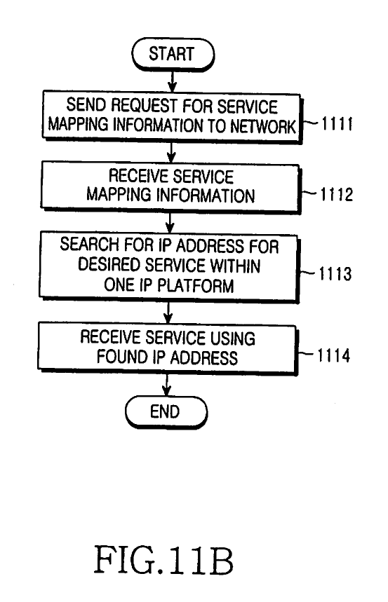

FIGS. 11A and 11B illustrate the IP address mapping method according to the third embodiment of the present invention in the terminal.

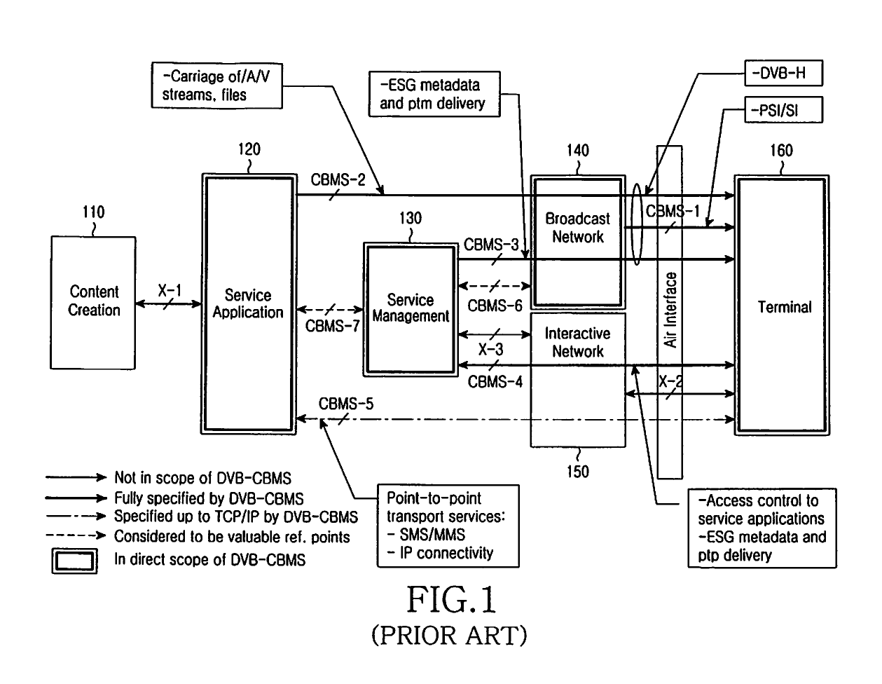

Referring to FIG. 1 IA, the terminal receives PSI/SI from the network in step 1101 and receives an ESG, a notification or any other signal in step 1102. The terminal acquires service mapping information from the received ESG, notification, or any other signal in step 1103. In step 1104, the terminal searches in the acquired service mapping information for an IP address in another provider, which corresponds to a currently received service from the current provider within a single IP platform. In step 1105, the terminal continues receiving the desired service from the other provider using the found IP address.

The terminal may also send a request for the service mapping information to the network.

In other words, as illustrated in FIG. 11B, when the terminal desires to continue receiving the currently received service from another provider, it sends a request for desired service mapping information to the network in step 1111 and receives the service mapping information in step 1112. In step 1113, the terminal searches in the acquired service mapping information for an IP address in the other provider, which corresponds to the currently received service from the current provider within a single IP platform. In step 1114, the terminal continues receiving the desired service from another provider using the found IP address.

In the third embodiment of the present invention, for fast and efficient service reception change of the terminal, a mapping IP address, a service ID, and other information such as a frequency, a network and a cell ID may be delivered together to the terminal.

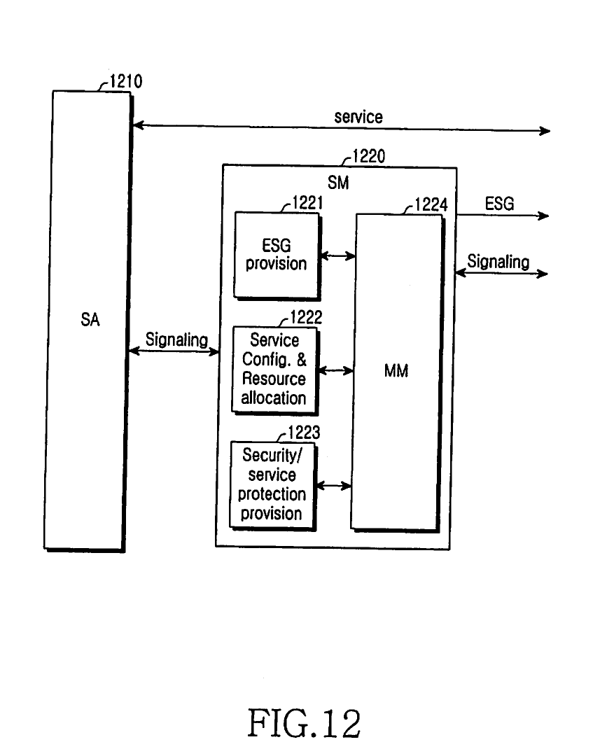

FIG. 12 illustrates the structure of a network according to the present invention.

Referring to FIG. 12, a Service Application (SA) 1210 aggregates contents from multiple sources and their related metadata in order to provide a particular service application, provides head-end application logic and contents encoded in the format understood by the terminal either via streaming or file carousel delivery, and generates metadata to be used for an ESG. The SA 1210 may exist for each application provided in IP Datacast.

A Service Management (SM) 1220 includes an ESG provision 1221, a service configuration/resource allocation 1222, a security/service protection provision 1223 and a Mobility Management (MM) 1224 as its sub-entities. The MM 1224 supports a roaming process by communicating with the other three entities 1221 through 1223, transmits/receives roaming request and response, supports a roaming process by communicating with other entities and sub-entities and communicates with an MM of another network for information exchange. The service configuration/resource allocation 1222 registers service applications that contend for the bandwidth of a broadcast bearer, assigns services to location related to broadcast network topology and bandwidth and schedules services over time. The ESG provision 1221 aggregates ESG (metadata information) pieces from the SA 1210. The security/service protection provision 1223 manages user access to the SA 1210.

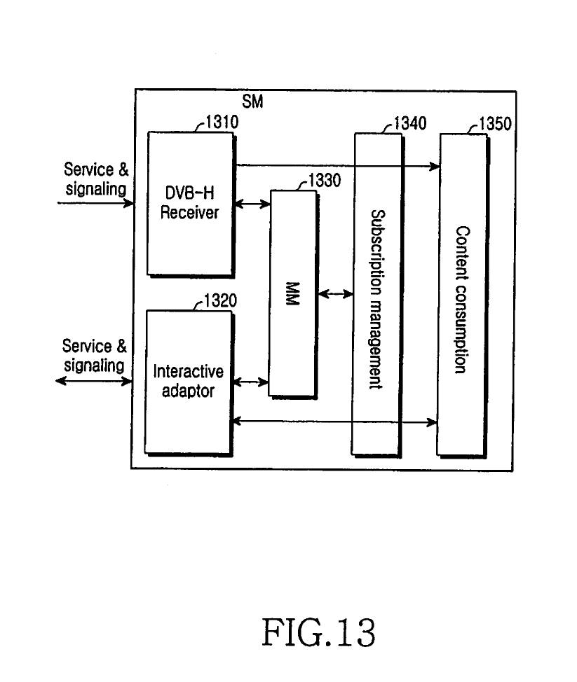

FIG. 13 illustrates the structure of a terminal according to the present invention.

Referring to FIG. 13, a DVB-H receiver 1310 controls reception and reconstruction of a DVB-H broadcast signal. An interactive adaptor 1320 provides a service using a mobile communication network. An MM 1330 manages a reception environment change caused by movement of the terminal. A subscription management 1340 manages right acquisition, keeps track of rights acquired for the terminal and controls the decryption process of service contents. A content consumption 1350 sends a received broadcast service to a user.

As is apparent from the foregoing description, by providing service mapping information between different providers for the same or similar services to a terminal in a digital broadcasting system, the terminal can be provided with service continuity.

While the invention has been shown and described with reference to exemplary embodiments thereof, it will be understood by those skilled in the art that various changes in form and details may be made therein without departing from the spirit and scope of the invention.

What is claimed is:

1. A method for providing a broadcast service to a terminal by a network in a digital broadcasting system, the method comprising:
collecting Internet Protocol (IP) address information for each of services provided by a plurality of IP platforms;
selecting a manner in which to transmit the collected IP address information to the terminal; and
transmitting the collected IP address information to the terminal in the selected manner.

2. The method of claim 1, wherein the IP address information includes IDentifiers (IDs) of the IP platforms that provide the same or similar services and an IP address for each of the services provided by each of the IP platforms.

3. The method of claim 1, wherein the selection of the manner in which to transmit the collected IP address information includes selecting one of an Electronic Service Guide (ESG), a notification message and signaling.

4. The method of claim 3, further comprising receiving a request message for the IP address information from the terminal prior to the collection of the IP address information.

5. A method for receiving a broadcast service from a network by a terminal in a digital broadcasting system, the method comprising:
receiving Internet Protocol (IP) address information for each of services provided by a plurality of IP platforms from the network;
checking, if a currently received service is the same as a service provided by another IP platform, IP address information of the service provided by the another IP platform; and
continuing to receive the service provided by the another IP platform using the checked IP address information.

6. The method of claim 5, wherein the IP address information includes IDentifiers (IDs) of the IP platforms that provide the same or similar services and an IP address for each of the services provided by each of the IP platforms.

7. The method of claim 5, wherein the reception of the IP address information includes receiving the IP address information using one of an Electronic Service Guide (ESG), a notification message and signaling.

8. The method of claim 3, further comprising transmitting a request message for the IP address information from the terminal prior to the reception of the IP address information.

9. A method for providing a broadcast service to a terminal by a network in a digital broadcasting system, the method comprising:
collecting service IDentifier (ID) information for each of services provided by a plurality of providers;
selecting a manner in which to transmit the collected service ID information to the terminal; and
transmitting the collected service ID information to the terminal in the selected manner.

10. The method of claim 9, wherein the service ID information includes IDs of the providers which provide the same or similar services and a service ID provided for each of the IP platforms.

11. The method of claim 9, wherein the selection of the manner in which to transmit the collected service ID information includes selecting one of an Electronic Service Guide (ESG), a notification message and signaling.

12. The method of claim 11, further comprising receiving a request message for the service ID information from the terminal prior to the collection of the service ID information.

13. A method for receiving a broadcast service from a network by a terminal in a digital broadcasting system, the method comprising:
receiving service IDentifier (ID) information for each of services provided by a plurality of providers from the network;
checking, if a currently received service is also provided by another provider, service ID information of the service provided by the another provider; and
continuing to receive the service provided by the another provider using the checked service ID information.

14. The method of claim 13, wherein the service ID information includes IDs of the providers which provide the same or similar services and a service ID provided for each of Internet Protocol (IP) platforms for the services.

15. The method of claim 13, wherein the reception of the service ID information comprises receiving the service ID information using one of an Electronic Service Guide (ESG), a notification message and signaling.

16. The method of claim 15, further comprising transmitting a request message for the service ID information to the network prior to the reception of the service ID information.

17. A method for providing a broadcast service to a terminal by a network in a digital broadcasting system, the method comprising:
collecting service IDentifier (ID) information and Internet Protocol (IP) address information for each of services provided by a plurality of providers within a single IP platform;
selecting a manner in which to transmit the collected service ID information and IP address information to the terminal; and
transmitting the collected service ID information and IP address information to the terminal in the selected manner.

18. The method of claim 17, wherein the service ID information and IP address information include IDs of the providers that provide the same or similar services and an IP address for each of the services provided by each of the providers.

19. The method of claim 17, wherein the selection of the manner in which to transmit the collected service ID information and IP address information includes selecting one of an Electronic Service Guide (ESG), a notification message and signaling.

20. The method of claim 17, further comprising receiving a request message for the service ID information and IP address information from the terminal prior to the collection of the service ID information and IP address information.

21. A method for receiving a broadcast service from a network by a terminal in a digital broadcasting system, the method comprising:
receiving service IDentifier (ID) information and Internet Protocol (IP) address information for each of services provided by a plurality of providers within a single IP platform;
checking, if a currently received service is also provided by another provider, service ID information and IP address information of the service provided by the another provider; and
continuing to receive the service provided by the another provider using the checked service ID information and IP address information.

22. The method of claim 20, wherein the service ID information and IP address information include IDs of the providers that provide the same or similar services and an IP address for each of the services provided by each of the providers.

23. The method of claim 20, wherein the reception of the service ID information and IP address information includes receiving the service ID information and IP address information using one of an Electronic Service Guide (ESG), a notification message and signaling.

24. The method of claim 20, further comprising transmitting a request message for the service ID information and IP address information to the network prior to the reception of the service ID information and IP address information.

25. A network device for providing a broadcast service to a terminal in a digital broadcasting system, the network device comprising:
a Service Application (SA) for aggregating contents from sources and their related metadata in order to provide an application for a particular service; and
a Service Management (SM) for generating an Electronic Service Guide (ESG) for the broadcast service from the metadata collected by the SA and managing roaming of the terminal to a neighboring network,
wherein the SM collects mapping information of services provided from different Internet Protocol (IP) platforms or different providers from the IP platforms or providers and provides the collected mapping information to the terminal.

26. The network device of claim 25, wherein the mapping information includes IDentifiers (IDs) of the IP platforms that provide the same or similar services and an IP address for each of the services provided by each of the IP platforms,
includes IDs of the providers that provide the same or similar services and service IDs of the services provided by the providers, or
includes the IDs of the providers that provide the same or similar services and an IP address for each of the services provided by each of the providers.

27. The network device of claim 25, wherein the SM provides the mapping information using one of the ESG; a notification message and signaling.

28. A terminal device for receiving a broadcast service from a network, the terminal device comprising:
a broadcasting receiver for receiving a broadcast service or signal from a broadcast network;
an interactive adaptor for receiving an interactive service or signal from an interactive network; and
a mobility management and control for managing roaming to a neighboring network,
wherein the broadcasting receiver receives mapping information for services provided from different Internet Protocol (IP) platforms or different providers from a network, and the mobility management and control controls to receive a desired service from an IP platform other than an IP platform in which the terminal device is currently located or a provider other than a provider from which the terminal device currently receives the service.

29. The terminal device of claim 28, wherein the mapping information includes IDentifiers (IDs) of the IP platforms that provide the same or similar services and an IP address for each of the services provided by each of the IP platforms,
includes IDs of the providers that provide the same or similar services and service IDs of the services provided by the providers, or includes the IDs of the providers that provide the same or similar services and an IP address for each of the services provided by each of the providers.

30. The terminal device of claim 29, wherein the broadcasting receiver receives the mapping information using one of an Electronic Service Guide (ESG), a notification message and signaling.
